(19) United States
(12) Patent Application Publication
(10) Pub. No.: US 2022/0277380 A1
(43) Pub. Date: Sep. 1, 2022

(54) COOPERATIVE SUPPLY AND DISTRIBUTION CHAIN PROCESSING

(71) Applicant: NCR Corporation, Atlanta, GA (US)

(72) Inventor: David Charles Olds, Woodstock, GA (US)

(21) Appl. No.: 17/186,073

(22) Filed: Feb. 26, 2021

(51) Int. Cl. G06Q 30/06; H04L 9/06; G06Q 10/06; G06Q 20/38

(52) U.S. Cl. CPC G06Q 30/0635; H04L 9/0643; G06Q 10/0633; G06Q 20/3829; H04L 2209/38

(57) ABSTRACT

A ledger associated with a Purchase Order (PO) is maintained in a private blockchain among entities associated with the PO. An Application Programming Interface (API) is provided to hash and store ledger entries, ledger accesses, and/or documents associated with the PO. An interface is provided that uses the API to obtain the ledger, selective entries of the ledger, the PO, selective portions of the PO, ledger accesses, and/or selective documents associated with the PO from the private blockchain.

### BACKGROUND

Retailers maintain their own independent inventory/purchasing systems for purposes of tracking a variety of information, such as purchase orders, fulfillment, shipping, and delivery. Each system has some form of ledger that is independently maintained across the disparate systems by each retailer for purposes of tracking any given purchase order and that retailer's status with respect to the purchase order. For any given purchase order, a plurality of retailers are typically involved; for example, one retailer may be the ordering retailer, one may be the supplying retailer, one may be the shipping retailer.

Electronic Data Interfaces (EDIs) are used for automated submission, tracking, and querying of purchase orders between the retailers. Each disparate system has different requirements resulting in a complex exchange of documents and information between purchase requestors, suppliers, manufactures, distributors, and shippers. Identifying an origin of an ordered product, tracking the product, and obtaining a chain of evidence when things go awry for insurance liability purposes are extremely difficult tasks even with existing EDIs (and other formats/standards available in the industry besides EDIs).

Additionally, each retailer in the supply and distribution chain for a given purchase order may believe based on their systems that the purchase order is in a different state than other retailers in the chain as there is no consistent, unified, and up-to-date view of a purchase order state available.

Furthermore, each retailer may often develop specialized software applications that use EDIs (or other formats/standards) for the sole purpose of automating interactions between that retailer's system and the various systems of other retailers commonly associated with the supply and distribution chain. This requires staffing or a third-party development resources to maintain when changes, upgrades, or patches are made in any of the systems.

### SUMMARY

In various embodiments, methods and a system for cooperative supply and distribution processing are presented.

According to an embodiment, a method for cooperative supply and distribution processing is presented. More particularly, an indication is received indicating that a purchase order (PO) was created by an entity within a workflow of a system for the entity. An Application Programming Interface (API) call is provided to process on an entity device that creates a ledger associated with the entity and the PO within a private blockchain (BC) cooperatively maintained by the entity and other entities over a distributed network.

### BRIEF DESCRIPTION OF THE DRAWINGS

FIG. 1 is a diagram of a system for cooperative supply and distribution processing, according to an example embodiment.

FIG. 2 is a diagram of a method for cooperative supply and distribution processing, according to an example embodiment.

FIG. 3 is a diagram of another method for cooperative supply and distribution processing, according to an example embodiment.

### DETAILED DESCRIPTION

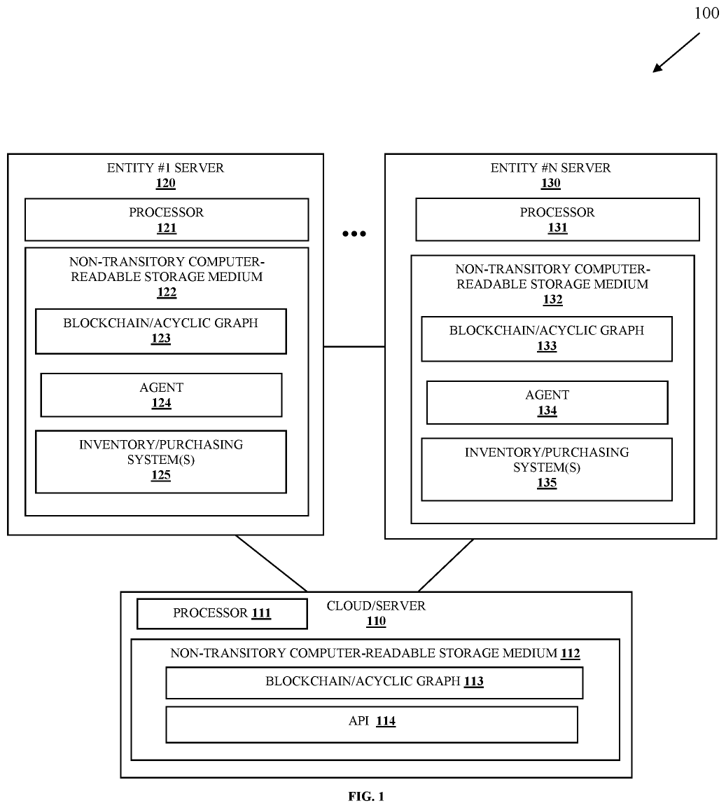

FIG. 1 is a diagram of a system 100 for cooperative supply and distribution processing, according to an example embodiment. The various components are illustrated, and the arrangement of the components is presented for purposes of illustration only. It is to be noted that other arrangements with more or less components are possible without departing from the cooperative supply and distribution teachings presented herein and below.

The techniques, methods, and system presented herein and below for cooperative supply and distribution processing can be implemented in whole or in part in one, all, or some combination of the components shown with the system 100. The techniques and methods are programmed as executable instructions in memory and/or non-transitory computer-readable storage media and processed on one or more processors associated with the various components.

The terms “entity,” “retailer,” and/or “establishment” may be used synonymously and interchangeably. These terms refer to businesses associated with a purchase order of goods/products in some way (e.g., having some role or obligation with respect to the purchase order (requestor or originator, manufacturer, supplier, distributor, shipper, etc.)).

It is to be noted that wherever the term “PO” is used herein it is intended to not only include the PO document itself but, in some embodiments, can also include all the associated document related to the PO.

As will be demonstrated in greater detail herein and below, system 100 provides a mechanism by which a ledger associated with a purchase order and the component documents associated with that ledger can be securely stored and recalled from a private blockchain (BC) and/or Acyclic Graph (graph).

System 100 provides a great deal of benefits to the entities associated with originating, fulfilling, shipping, and receiving goods associated with purchase orders (POs). First, the entities work off a same consistent ledger (although each entity may still separately maintain their version of the ledger in their native systems). Second, the documents associated with the ledger and the ledger itself are secure with access only possible by the entities possessing the appropriate public and private keys for obtaining the documents. Third, the entities can obtain a current state of a purchase order and location(s) of the corresponding goods as a consistent state that does not differ between the entities based on the entities' native systems. Fourth, at any time, a chain of document evidence with respect to a given ledger can be assembled from the BC/graph for dispute resolution and/or insurance liability purposes. Fifth, existing EDIs (and other existing formats/standards used in the industry) that are processed by existing systems of the entities may still be used for inter-entity communications by translating between BC/graph-based operations and EDI-based operations, such that no changes or minimal changes are necessary to the entities native systems when deploying system 100. Sixth, each entity may have their own internal reference numbers and/or labels, which are not typically accessible or known to the other entities; these unique internal reference numbers and/or labels can be added by the entities to the ledger and/or documents associated with the ledger and made visible to the other entities or maintained as private by a particular retailer through the BC/graph.

System 100 comprises a cloud/server 110 and a plurality of entity servers 120 to 130 (entity #1 120 through entity #2 130).

Cloud/server 110 comprises at least one processor 111 and a non-transitory computer-readable storage medium 112. Medium 112 comprises executable instructions for an Application Programming Interface (API) 114 for performing operations on a BC/graph 113. The executable instructions when executed by processor 111 performs operations discussed herein and below for API 114.

Each entity server 120 to 130 comprises a processor 121 to 131 and a non-transitory computer-readable storage medium 122 to 132. Each medium 122 to 132 comprises executable instructions for an agent 124 to 134 and an inventory/purchasing system 125 to 135. When each agent 124 to 134 is executed by the corresponding processor 121 to 131, this causes processor 121 to 131 to perform operations discussed herein and below for agent 124 to 134 and systems 125 to 135. Each medium 122 to 132 also comprises its maintained portion of BC/graph 123 to 133 in the private BC/graph.

Servers 120 to 130 and cloud/server 110 maintains a portion of a private BC/graph (shown as 113, 123, and 133). API 114 initiates through BC/graph (113, 123, and 133) storage of documents and ledgers and retrieval of documents and ledgers associated with POs.

Workflows associated with systems 125 and 135 are either monitored by agents 124 and 134 or are modified to call agents 124 and 135. Agent 124 makes a call to obtain a corresponding API call 114 from API 114, the API call initiates a put of information or a get of information from the BC/graph (113, 123, and 133). Any other information needed with the API call, such as Public keys of the entity are supplied by agent 124 or 134.

Each agent 124 to 134 also assembles returned component pieces of the BC/graph (113, 123, and 133) when that agent 124 to 134 initiated a get of information from the BC/graph (113, 123, and 133). That is, if agent 124 requested to obtain a ledger for a given PO from cloud/server 110, cloud/server 110 returns the appropriate get API call from API 114 to agent 124. When the get API call is processed, all other agents 134 needed to obtain their portion of the ledger from the BC/graph (113, 123, and 133) are called, each agent 134 (note agent 124 may have a portion of the ledger in its portion of BC/graph 123) obtains its portion of the ledger and returns to the calling agent 124. Calling agent 124 assembles the component pieces into the ledger and provides through a user-facing interface to agent 124 to a user or provides through a different API to an existing service of system 125.

The BC/graph (113, 123, and 133) utilizes two types of data provided during gets and puts: hash values of keys or identifiers and any text/image data that is associated with the keys or identifiers. The hash values of the keys are performed by API calls of API 114 to locate blocks within the (113, 123, and 133) and obtain or store the text/image data. Each agent 124 to 134 maintains keys associated with its retailer (public and private key) and keys associated with documents and ledger entries that original from its systems 125 to 135. Get operations (or requests for documents of a ledger or the ledger itself) require no text data for initiating the get operations, just the corresponding keys associated with the requesting entity, documents, and ledger are needed. Each agent 124 to 134 performs hashes on the corresponding keys defined by the API calls to put or to obtain data onto its portion of the BC (113, 123, and 133).

The API 114 defines the hashing algorithm used by the agents 124 and all that is passed between agents is the keys and the corresponding data associated with a put or associated with returned data from a get operation. Access to the ledger as a whole requests a public and private key pair associated with the originator (PO creator) and a public key of the ledger. The public key of the ledger may be shared between agents 124 but never the corresponding private key. In this way, each entity can only retrieve from the BC/graph (113, 123, and 133) entries made in a given ledger or documents generated by that entity.

When a workflow associated with one of the systems 125 to 135 creates a document or an entry into the ledger, all of the agents 124 to 134 receive notice based on the corresponding operations performed to store the entry or document in the BC/graph (113, 123, and 133) along with the appropriate public keys (for example, entity public key, ledger public key, document public key, etc.) that were needed to perform the put operation. This allows the originator of the PO to receive a real-time notice through the corresponding agent 124 or 134. Agent 124 or 134 may be further enabled to translate the put operation associated with the ledger into an EDI API call (or other industry format and standard API calls) specific to the system 125 or 135 to automatically notify the originator. A user-facing interface of agent 124 or 134 can be accessed to issue a request to obtain the ledger entry or document from the BC/graph (113, 123, and 133).

An example workflow for ledger entries may proceed as follows. System 125 identifies that replenishment of a good is needed by entity #1, system 125 generates a PO, and vendor (entity #N) terms and details for the purchase order are obtained. A workflow within system 125 is monitored by agent 124 or agent 124 is called by the workflow to create a ledger entry for the PO. Agent 124 obtains the appropriate API call from API 114 to create the ledger entry in BC/graph (113, 123, and 133). Workflow of system 125 then submits the PO along with the terms and details to vendor (entity #N) for internal approval within entity #1 and agent 124 obtains the appropriate API call from API 114 to insert this as a second entry of the ledger within the BC/graph (113, 123, and 133). Workflow of system 125 then identifies an internal approval (potential ledger entry) for the PO and sends the PO for approval to entity #1 (entry made within the ledger and BC/graph (113, 123, and 133) initiated by agent 124). Note the request made can either be achieved through inter-agent communications by agent 124 providing the public key to the PO to agent 134 and/or through an existing EDI API communication (or other format or standard API communication in the industry) for receipt and processing by system 135 and the existing EDI API communication modified to include the public key of the PO as provided by agent 124. Agent 134 is initiated to call cloud/server 110 and obtain an API call to initiate a get for the PO. Agent 134 processes the corresponding API call with a public keys of entity #1, the PO, and entity #1. The BC/graph (113, 123, and 133) returns the PO and just the component information associated with the PO assigned to entity #N. Entity #N accepts the terms and details associated with entity #N within a workflow of system 135. Agent 134 initiates an entry into the ledger for the PO for the acceptance within BC/graph (113, 123, and 133). This process continues when entity #N fulfills the PO assigned to entity #N or engages a supplier to fulfill the PO (the supplier would be entity #N+1 in the example). The receiving of the goods from entity #N (or entity #N+1) by entity #1 is scheduled resulting in another entity within the ledger for the PO. A workflow within system 125 starts initial payment processing for the goods to entity #N based on the terms of the PO. The goods or items are received by entity #1 resulting in an entry within the ledger. Any adjustments based on a wrong item/good, a wrong number of items/goods, or damaged items/goods are made by entity #1 resulting in a ledger entry. Payment is made by entity #1 to entity #N resulting in a ledger entry. Entity #1 then stocks the items/goods within a store or warehouse and updates any inventory through system 125.

It is noted that a various alterations or deviations from the above-noted example can be achieved.

It is also noted the ledger entries need not include any information or data created within a new entry of the ledger but can be a notation associated with the ledger when access is made by either of the entities to the ledger (such that agents 124 and 134 can record audit or access operations within a portion of the ledger).

Furthermore, entity #N (referring to the above-noted example) may supply with its own acceptance reference numbers for the PO, received order date, item details, and/or item origin information or as part of its internal system 135, which may be maintained publicly or privately on the ledger by entity #N through agent 134.

In an embodiment, agents 124 and 134 comprise a user-facing interface that permits reconstruction of the ledger for any given PO; however, just the entries and corresponding audit data created by the requesting entity or made public by other entities is provided back to the user operating the user-facing interface. In this way, each entity may record or make notations on the ledger that are both public and private.

In an embodiment, agents 124 and 134 translates documents retrieved from the BC/graph (113, 123, 133) into formats and communications expected by existing processes of an existing workflow of systems 125 and 135.

In an embodiment, EDI (or other format and standards in the industry) communications are monitored from workflows of systems 125 and 135 and translated when necessary into puts or gets that are to be made within the BC/graph (113, 123, 133).

In an embodiment, cloud/server 110 need not maintain any portion of BC/graph (123 and 133), such that the BC/graph is owned and controlled exclusively by the entity servers 120 and 130.

In an embodiment, each entity server 120 and 130 comprises the API 114, such that the specific API calls needed for the gets and puts to the BC/graph (123 and 133) does not require a call to cloud/server 110.

In an embodiment, the user-facing interface that permits reconstruction of the ledger, querying of the ledger, and/or auditing of the ledger is provided as an application from cloud/server 110; rather than through agents 124 and 134.

In an embodiment, the BC/graph (113, 123, 133) is more granular than what was described above, such that items include item identifiers, and store or warehouses include identifiers. Agents 124 and 135 and/or a user-facing interface to the BC/graph (113, 123, 133) from cloud/server 110 permit fine-grain searching of the BC/graph (113, 123, 133) on item or store levels to obtain all POs associated with a given item or a given store or a combination of a given item and store. In an embodiment, each entity 120 or 130 can independently decide how granular they want to maintain their information within the BC/graph (113, 123, 133), such that one entity may only include ledger and PO entries while a different entity may maintain item-level and store-level detail on PO and ledger entries. This configuration can be achieved as parameters to agents 124 or 134.

In an embodiment, payment processing can be achieved through agents 124 and 134 or a payment BC service of cloud/server 110 for fulfilled POs using cryptocurrency with modified workflows within systems 125 and 135 that supply digital wallet addresses and an amount of a given cryptocurrency.

In an embodiment, document images associated with ledger entries are maintained within the BC/graph (113, 123, 133).

In an embodiment, just entries or accesses made to a given ledger for a given PO are maintained within the BC/graph (113, 123, 133).

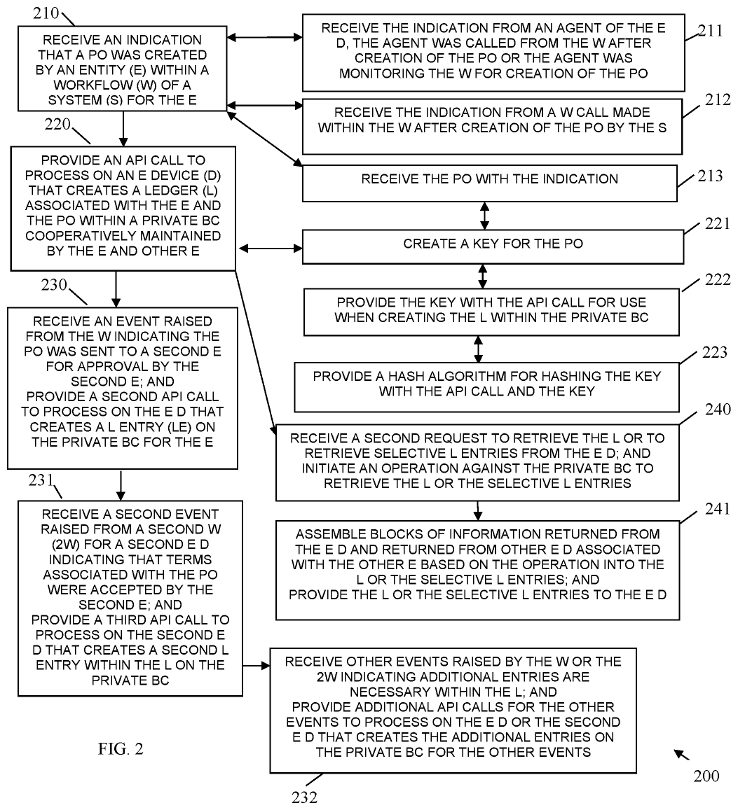

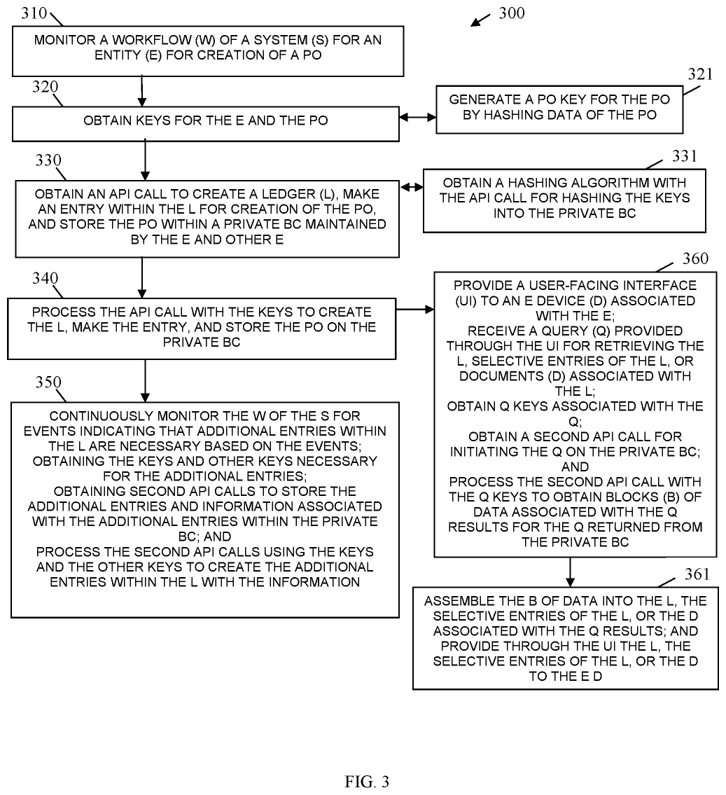

The above-discussed embodiments with system 100 and other embodiments are now discussed with reference to FIGS. 2-3.

FIG. 2 is a diagram of a method for cooperative supply and distribution processing, according to an example embodiment. The software module(s) that implements the method 200 is referred to as a “cooperative BC API provider.” The cooperative BC API provider is implemented as executable instructions programmed and residing within memory and/or a non-transitory computer-readable (processor-readable) storage medium and executed by one or more processors of a device. The processor(s) of the device that executes the cooperative BC API provider are specifically configured and programmed to process the cooperative BC API provider. The cooperative BC API provider has access to one or more networks during its processing. The networks can be wired, wireless, or a combination of wired and wireless.

In an embodiment, the cooperative BC API provider is executed by server 110.

In an embodiment, the cooperative BC API provider is executed by cloud 110 comprising a plurality of servers logically organized as a single processing environment.

In an embodiment, the cooperative BC API provider is API 114.

At 210, the cooperative BC API provider receives an indication that a PO was created by an entity within a workflow of a system for the entity.

In an embodiment, at 211, the cooperative BC API provider receives the indication from an agent of an enterprise device. The agent was called from the workflow after creation of the PO or the the agent was monitoring the workflow for creation of the PO.

In an embodiment, at 212, the cooperative BC API provider receives the indication from a workflow call made within the workflow after creation of the PO by the system. In this embodiment, the workflows discussed with system 100 are modified to make calls to server 110.

In an embodiment, at 213, the cooperative BC API provider receives the PO document with the indication.

At 220, the cooperative BC API provider provides an API call to process on the entity device that creates a ledger associated with the enterprise and the PO within a private BC/graph that is cooperatively maintained by the entity and other entities over a distributed network.

In an embodiment of 213 and 220, at 221, the cooperative BC API provider creates a key for the PO using a key associated with the entity and data hashed from the PO document associated with the PO.

In an embodiment of 221 and at 222, the cooperative BC API provider provides the key with the API call for use when creating the ledger within the private BC/graph.

In an embodiment of 222 and at 223, the cooperative BC API provider provides a hash algorithm for hashing the key with the API call and the key.

In an embodiment, at 230, the cooperative BC API provider receives an event raised from the workflow indicating that the PO was sent to a second entity for approval by the second entity. The cooperative BC API provider provides a second API call to process on the entity device that creates the ledger entry on the private BC/graph.

In an embodiment of 230 and at 231, the cooperative BC API provider receives a second event raised from a second workflow for a second entity device indicating that terms associated with the PO were accepted by the second entity. The cooperative BC API provider provides a third API call to process on the second entity device that creates a second ledger entry within the ledger on the private BC/graph.

In an embodiment of 231 and at 232, the cooperative BC API provider receives other events raised by the workflow or the second workflow indicating that additional entries are necessary within the ledger. The cooperative BC API provider provides additional API calls for the other events to process on the entity device or the second entity device that creates the additional entries on the private BC/graph for the other events.

In an embodiment of 220 and at 240, the cooperative BC API provider receives a second request to retrieve the ledger or to retrieve selective entries from the entity device. The cooperative BC API provider initiates an operation against the private BC/graph to retrieve the ledger or the selective ledger entries.

In an embodiment of 240 and at 241, the cooperative BC API provider assembles blocks of information returned from the entity device and returned from other entity devices associated with the other entities based on the operation into the ledger or the selective ledger entries. The cooperative BC API provider provides the ledger or the selective ledger entries to the entity device.

FIG. 3 is a diagram of another method for cooperative supply and distribution processing, according to an example embodiment. The software module(s) that implement the method 300 is referred to herein as a “BC-based supply and distribution chain agent.” The BC-based supply and distribution chain agent is implemented as executable instructions and programmed within memory and/or a non-transitory computer-readable (processor-readable) storage medium that executes on one or more processors of a device. The processors of the device are specifically configured to execute the BC-based supply and distribution chain agent. The BC-based supply and distribution chain agent has access one or more networks; the networks can be wired, wireless, or a combination of wired and wireless.

In an embodiment, the BC-based supply and distribution chain agent is agent 124 and/or API 114.

In an embodiment, the device that executes the BC-based supply and distribution chain agent is server 120 or server 130.

In an embodiment, the BC-based supply and distribution chain agent interacts with method 200 to obtain API calls from API 114.

At 310, the BC-based supply and distribution chain agent monitors a workflow of a system for an entity for creation of a PO.

At 320, the BC-based supply and distribution chain agent obtains keys for the entity and the PO.

In an embodiment, at 321, the BC-based supply and distribution chain agent generates a PO key for the PO based on hashing data of the PO document associated with the PO.

At 330, the BC-based supply and distribution chain agent obtains an API call to create a ledger, make an entry within the ledger for creation of the PO, and store the PO within a private BC/graph maintained by the entity and other entities over a distributed network.

In an embodiment, at 331, the BC-based supply and distribution chain agent obtains a hashing algorithm with the API call for hashing the keys into the private BC/graph.

At 340, the BC-based supply and distribution chain agent processes the API call with the keys to create the ledger, make the entry, and store the PO document associated with the PO on the private BC/graph.

In an embodiment, at 350, the BC-based supply and distribution chain agent continuously monitors the workflow of the system for events indicating that additional entries within the ledger are necessary based on the events. The BC-based supply and distribution chain agent obtains the keys and other keys necessary for the additional entries. The BC-based supply and distribution chain agent obtains second API calls to store the additional entries and information associated with the additional entries within the private BC/graph. The BC-based supply and distribution chain agent processes the second API calls using the keys and the other keys to create the additional entries within the ledger with the information.

In an embodiment, at 360, the BC-based supply and distribution chain agent provides a user-facing interface (UI) to an entity device associated with the entity. The BC-based supply and distribution chain agent receives a query provided through the UI for retrieving the ledger, selective entries of the ledger, or documents associated with the ledger. The BC-based supply and distribution chain agent obtains query keys associated with the query and obtains a second API call for initiating the query on the private BC/graph. The BC-based supply and distribution chain agent processes the second API call with the query keys to obtains blocks of data associated with the query results for the query that are returned from the private BC/graph.

In an embodiment of 360 and at 361, the BC-based supply and distribution chain agent assembles the blocks of data into a correct sequence for the ledger, the selective entries of the ledger, or the documents associated with the query results. The BC-based supply and distribution chain agent provides through the UI the assembled ledger, the selective entries of the ledger, or the document to the entity device for displaying through the UI to a user interacting with the UI on the entity device.

It should be appreciated that where software is described in a particular form (such as a component or module) this is merely to aid understanding and is not intended to limit how software that implements those functions may be architected or structured. For example, modules may be illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors of a single device, or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving an indication that a purchase order (PO) was created by an entity within a workflow of a system for the entity; and
providing an Application Programming Interface (API) call to process on an entity device that creates a ledger associated with the entity and the PO within a private blockchain (BC) cooperatively maintained by the entity and other entities.

2. The method of claim 1, wherein receiving further includes receiving the indication from an agent of the entity device, wherein the agent was called from the workflow after creation of the PO or that was monitoring the workflow for creation of the PO.

3. The method of claim 1, wherein receiving further includes receiving the indication from a workflow call made within the workflow after creation of the PO by the system.

4. The method of claim 1, wherein receiving further includes receiving the PO with the indication.

5. The method of claim 4, wherein providing further includes creating a key for the PO.

6. The method of claim 5, wherein creating further includes providing the key with the API call for use when creating the ledger within the private blockchain.

7. The method of claim 6, wherein providing the key further includes providing a hash algorithm for hashing the key with the API call and the key into the private blockchain by the entity and the other entities.

8. The method of claim 1 further comprising:
receiving an event raised from the workflow indicating the PO was sent to a second entity for approval by the second entity; and
providing a second API call to process on the entity device that creates a ledger entry within the ledger on the private blockchain for the event.

9. The method of claim 8 further comprising:
receiving an event raised from a second workflow of a second entity device for the second entity indicating that terms associated with the PO were accepted by the second entity; and
providing a third API call to process on the second entity device that creates a second ledger entry within the ledger on the private blockchain for the second event.

10. The method of claim 9 further comprising:
receiving other events raised by the workflow or the second workflow indicating additional entries are necessary within the ledger; and
providing additional API calls for the other events to process on the entity device or the second entity device that creates the additional entries on the private blockchain for the other events.

11. The method of claim 1 further comprising:
receiving a second request to retrieve the ledger or to retrieve selective ledger entries from the entity device; and
initiating an operation against the private blockchain to retrieve the ledger or the selective ledger entries.

12. The method of claim 11 further comprising. assembling blocks of information returned from the entity device associated with the entity and returned from other entity device associated with the other entities based on the operation into the ledger or the selective ledger entries; and
providing the ledger or the selective ledger entries to the entity device.

13. A method, comprising:
monitoring a workflow of a system for an entity for creation of a Purchase Order (PO);
obtaining keys for the entity and the PO;
obtaining an Application Programming Interface (API) call to create a ledger for the PO, make an entry within the ledger for creation of the PO, and store the PO within a private blockchain maintained by the entity and other entities;
processing the API call with the keys to create the ledger, make the entry, and store the PO within the private blockchain.

14. The method of claim 13, wherein obtaining the keys further includes generating a PO key for the PO based by hashing data of the PO.

15. The method of claim 13, wherein obtaining the API call further includes obtaining a hashing algorithm with the API call for hashing the keys into the private blockchain.

16. The method of claim 13 further comprising:
continually monitoring the workflow of the system for events indicating that additional entries are necessary within the ledger based on the events;
obtaining the keys and other keys necessary for the additional entries;
obtaining second API calls to store the additional entries and information associated with the additional entries within the private blockchain; and
process the second API calls using the keys and the other keys to create the additional entries within the ledger with the information.

17. The method of claim 13 further comprising:
providing a user-facing interface to an entity device associated with the entity;
receiving a query provided through the user-facing interface for retrieving the ledger, selective entries of the ledger, or documents associated with the PO;
obtaining query keys associated with the query;
obtaining a second API call for initiating the query on the private blockchain; and
processing the second API call with the query keys to obtain blocks of data associated with query results for the query returned from the private blockchain.

18. The method of claim 17 further comprising:
assembling the blocks of data into the ledger, the selective entries of the ledger, or the documents associated with the query results; and
providing through the user-facing interface the ledger, the selective entries of the ledger, or the documents to the entity device.

19. A system, comprising:
a first server comprising a processor and a non-transitory computer-readable storage medium;
the non-transitory computer-readable storage medium comprises executable instructions;
a plurality of entity servers comprising entity devices; and
the executable instructions when executed by the processor from the non-transitory computer-readable storage medium cause the processor to perform operations comprising:
providing Application Programming Interface (API) calls to the entity devices that when processed by the entity devices create, maintain, and retrieve ledgers associated with Purchase Orders (POs), entries within the ledgers, and documents associated with the POs from a private blockchain that is maintained by the entity devices.

20. The system of claim 19, wherein the first server is associated with a cloud processing environment, and wherein the executable instructions is a cloud-based service for maintaining and managing the private blockchain.
